(19) United States
(12) Patent Application Publication
(10) Pub. No.: US 2011/0075208 A1
(43) Pub. Date: Mar. 31, 2011

(54) IMAGE FORMING APPARATUS, PRINT INSTRUCTING APPARATUS AND PRINT INSTRUCTING METHOD

(76) Inventor: Naofumi UEDA, Osaka (JP)

(21) Appl. No.: 12/890,831

(22) Filed: Sep. 27, 2010

(30) Foreign Application Priority Data
Sep. 30, 2009 (JP) 2009-226481

(51) Int. Cl. G06F 15/00

(52) U.S. Cl. 358/1.15

(57) ABSTRACT

An image forming apparatus includes: a receiving device receiving print data; a banner page generating function responsive to reception of the print data, for generating a banner page displaying information related to the print data and conditions at the time of forming the image of the page; an image generating function for generating image data based on the print data; an image forming unit, responsive to reception of the print data, for forming the generated banner page and an image generated based on the print data, on a medium; and a security setting storage device for storing security setting related to the banner page. The banner page setting function changes the information to be displayed on the banner page or the conditions at the time of image formation, in accordance with the setting stored in the security setting storage function (S504 to S508).

### CROSS-REFERENCE TO RELATED APPLICATION

This nonprovisional application claims priority under 35 U.S.C.§119(a) on Patent Application No. 2009-226481 filed in Japan on Sep. 30, 2009, the entire contents of which are hereby incorporated by reference.

### BACKGROUND OF THE INVENTION

1. Field of the Invention

The present invention relates to an image forming apparatus receiving image data and printing it on a sheet of recording paper and, more specifically, to an image forming apparatus having a function of forming a banner page indicating contents of a print job.

2. Description of the Background Art

An image forming apparatus such as a printer or a digital multifunction peripheral having the printer function receives print job data transmitted from an information processing terminal through LAN (Local Area Network), and analyzes and prints data. A printed sheet of recording paper is output to a discharge tray provided on the image forming apparatus. If a plurality of information processing terminals are connected to the LAN and the image forming apparatus is used, it is often the case that outputs of different print jobs are output to one discharge tray. Sometimes, a user forms and outputs a banner page as a divider separating one print job from another, to distinguish print job output of his/her own from print job output of another user.

The banner page may be generated inside the image forming apparatus, or generated by an information processing terminal or a printer server outside the image forming apparatus, as a banner page job. As a method of forming the banner page in the image forming apparatus, banner formation in accordance with LPR (Line Printer Remote) protocol (RFC1179) has been known. As a method of forming by an information processing terminal, banner page generation using a divider page in accordance with printer setting of Windows (registered trade mark) has been known.

On the banner page to be output, it is possible to print various pieces of information including: user name or user ID; name of a document of which printing is instructed; name of an information processing terminal and IP address allocated to the terminal; and date and time when print instruction is issued. These pieces of information may be used to distinguish printouts of the user from printouts of another user.

In connection with the technique of distinguishing printouts of users, Japanese Patent Laying-Open No. 2007-207235 (hereinafter referred to as “'235 Reference”) discloses a technique of inserting a divider page formed by the user before/after or between pages of electronic document to be printed. According to the technique disclosed in '235 Reference, it is possible to customize the divider page in a simple and easy manner for the user, and the divider page helps to prevent printouts from being erroneously taken out from the output tray.

Japanese Patent Laying-Open No. 2008-65775 (hereinafter referred to as “'775 Reference”) discloses a technique of combining additional information in accordance with attribute information of a user obtained through a network with print data in relation to printing of a page. According to the technique disclosed in '775 Reference, the additional information can be changed in accordance with the attribute information of the user, and hence, printout in accordance with the attribute of the user can be formed.

Recently, with increased interest to protection of personal information, image forming apparatuses and print systems come to have various functions to improve information security.

Functions of image forming apparatuses related to leakage prevention of personal information include: a user authentication function of allowing use of the apparatus only by an authorized user; and a confidential printing function of requesting input of a password before outputting print data and performing printing in response to input of a prescribed password. If the user authentication function is used, it is possible to form a transmission destinations list that can be viewed or edited user by user using, for example, a multifunction peripheral. The contents of a transmission destinations list cannot be seen from other users and, therefore, it is possible to prevent leakage of information related to transmission partners registered user by user. If the confidential printing function is used, the data is not output until a prescribed password is input by the user. As a result, leakage of information from the output printouts exposed to others can be prevented.

A banner page is effective in distinguishing printouts of one's own from printouts output by others. The generated banner page, however, may inadvertently include pieces of information related to the user and printing, leading to a new problem that various pieces of information may possibly be leaked from the generated banner page.

The technique disclosed in '235 Reference is for setting contents of a header, a footer and a separator page and inserting the contents in the print data in a simple and easy manner. Therefore, it does not ensure sufficient security protection. The technique disclosed in '775 Reference is for managing user attribute information transmitted from a user terminal and controlling execution of a desired function (printing) with the additional information. This technique, however, does not lead to improved security of user information.

### SUMMARY OF THE INVENTION

Therefore, it is desired to improve the security function in an image forming apparatus having the function of forming a banner page.

It is more desirable to provide an information processing terminal realizing improved security in forming the banner page information.

According to a first aspect, the present invention provides an image forming apparatus, including: a communication device for receiving print data; a banner page generating device, responsive to the communication device receiving the print data, for generating a banner page displaying information related to the received print data and conditions at the time of forming an image of the page; an image forming unit, responsive to the communication device receiving the print data, for forming the banner page generated by the banner page generating device and an image generated based on the print data on a prescribed medium; and a security setting storage device storing security setting related to the banner page. The banner page generating device changes, in accordance with the setting stored in the security setting storage device, the information related to the banner page or the conditions at the time of forming the image of the banner page by the image forming unit.

The banner page generating apparatus generates, in response to the communication device receiving the print data, a banner page displaying information related to the received print data and conditions at the time of image formation. In response to the communication device receiving the print data, the image forming apparatus forms an image generated based on the print data and the banner page generated by the banner page generating apparatus. The security setting storage device stores setting related to the security of the banner page.

The information displayed on the banner page or conditions at the time of image formation of the banner page are changed in accordance with the security setting related to the banner page. The manner of forming image data of banner page on a medium, and conditions at the time of image formation, such as the sheet of paper to be used, are changed in accordance with the security setting related to the banner page. Since the contents to be displayed and the manner of forming the banner page image on the medium are changed in accordance with the security setting, it becomes possible to form a page data that prevents important information from being inadvertently seen by an unintended viewer. As a result, an image forming apparatus having the function of forming a banner page from the results of print data analysis with improved security function can be provided.

Preferably, the security setting storage device includes a first setting storage device storing on/off setting of the security function of the image forming apparatus. The banner page generating device changes, in accordance with the on/off setting of the security function stored in the first setting storage device, the information to be displayed on the banner page or the conditions at the time of forming the image of the banner page by the image forming unit.

Depending on whether the security function is on or off, the information to be displayed on the banner page can be changed. As a result, the contents to be displayed on the banner page, or conditions at the time of forming the images for the banner page by the image forming apparatus can be changed as needed in a simple manner.

Preferably, the security setting storage device further includes a second setting storage device storing item information related to an item to be displayed on the banner page. The banner page generating device changes, in accordance with the on/off setting of the security function stored in the first setting storage device and the item information stored in the second setting storage device, the information to be displayed on the banner page or the conditions at the time of forming the image of the banner page by the image forming unit.

The item information to be displayed on the banner page can be stored, and depending on whether the security function is on or off, the information to be displayed on the banner page or the conditions at the time of forming the banner page by the image forming apparatus can be changed. The items to be displayed on the banner page or conditions of the medium at the time of image formation and the like can be set, and security management reflecting the intention of the administrator becomes possible.

Preferably, the print data additionally has user information identifying a user who instructed printing of the print data. The security setting storage device includes a first setting storage device storing information for setting user by user on/off of the security function of the image forming apparatus. The banner page generating device changes, in accordance with the user-by-user on/off setting of the security function stored in the first setting storage device and the user information added to the print data received by the communication device, the information to be displayed on the banner page or the conditions at the time of forming the image of the banner page by the image forming unit.

Depending on the on or off setting of the user-by-user security function and the user information added to the print data, the information to be displayed on the banner page or the conditions at the time of forming the banner page by the image forming apparatus can be changed. Since the user information is used in relation to the change of contents to be displayed on the banner page and the conditions of image formation, the contents to be displayed on the banner page can be changed and the conditions related to the image formation can be set finely user-by-user. As a result, security function related to the use of image forming apparatus can be improved as intended by the administrator.

The security setting storage device may include a first setting storage device storing item information related to an item to be displayed on the banner page. The banner page generating device changes, in. accordance with the item information stored in the first setting storage device, the information to be displayed on the banner page or the conditions at the time of forming the image of the banner page by the image forming unit.

Preferably, the image forming apparatus further includes a setting input device receiving a setting related to security of the image forming apparatus from a user and storing the setting in the security setting storage device.

Since security-related setting is received from the user, a banner page having the display contents as desired by the user, or conditions at the time of image formation of the banner page by the image forming unit as desired by the user can be formed. As a result, a banner page in accordance with the status of use and the security environment of the image forming apparatus can be formed.

According to a second aspect, the present invention provides a print instructing apparatus, including: an image forming unit, responsive to an instruction from a user, for generating print data to be transmitted to and printed by an image forming apparatus; an inquiry device, responsive to the instruction, for sending out an inquiry to the image forming apparatus about security-related setting of the image forming apparatus; a banner page generating device for generating, based on the security-related setting of the image forming apparatus obtained by the inquiry device, a print job of a banner page having contents made different depending on whether security function is on or off in the image forming apparatus; and a transmission device for transmitting the print job of a banner page generated by the banner page generating device and the print data generated by the image forming unit, to the image forming apparatus.

The image forming apparatus generates print data to be transmitted to and printed by the image forming apparatus, in response to an instruction by the user. The inquiry device inquires about security-related setting of the image forming apparatus, in response to the instruction from the user. The banner page generating device generates banner page print job of different contents depending on whether the security function is on or off in the image forming apparatus, based on the security-related setting of the image forming apparatus obtained by the inquiry device. The transmitting device transmits the banner page print job generated by the banner page generating device and the print data generated by the image forming unit, to the image forming apparatus.

Since the contents of a banner page are generated based on the security setting of the image forming apparatus as the transmission destination, it becomes possible to generate a banner page based on the setting of the output destination without the necessity of the user setting the security items each time. For each print instruction, inquiry about the security setting is made to the common image forming apparatus and, therefore, uniform security management becomes possible. As a result, improved security can be realized in forming banner page information.

Preferably, the banner page generating device further changes, if the security function is on in the image forming apparatus, contents of the banner page based on the security-related setting of the image forming apparatus.

If the security setting is on in the image forming apparatus, the contents of the banner page generated by the print instructing apparatus are further changed. Since the contents of the banner page are changed in accordance with the security setting of the image forming apparatus, an appropriate banner page in accordance with the security setting can be generated.

Preferably, the banner page generating device sets, if the security function is on in the image forming apparatus, contents of the banner page based on the security-related setting of the image forming apparatus and user information of a user operating the print instructing apparatus.

Since the contents of the banner page are changed in consideration of the user information, it becomes possible to realize setting related to the contents of the banner page user by user. As a result, the security function can further be improved.

In the image forming apparatus, the information displayed on the banner page and the manner of banner page formed on the medium, or the conditions at the time of image formation of the banner page by the image forming apparatus are changed in accordance with the security setting related to the banner page. Since the contents to be displayed and the manner on the medium are changed in accordance with the security setting, it becomes possible to form a banner page not including any important information. As a result, an image forming apparatus having a function of forming a banner page from the result of analysis of the print data realizing improved security function can be provided.

According to a third aspect, the present invention provides a print instructing method, including the steps of: in response to an instruction from a user, generating print data to be transmitted to and printed by an image forming apparatus; in response to the instruction, sending out an inquiry to the image forming apparatus about security-related setting of the image forming apparatus; based on the security-related setting of the image forming apparatus obtained at the inquiry step, generating a print job of a banner page having contents made different depending on whether security function is on or off in the image forming apparatus; and transmitting the print job of a banner page generated at the print job generating step and the print data generated at the print data generating step, to the image forming apparatus.

According to a fourth aspect, the present invention provides a storage medium that stores a program causing, when executed by a computer, the computer to execute each of the steps of print instructing method described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a print system 30 in accordance with a first embodiment of the present invention.

FIG. 2 is a block diagram showing a configuration of an image forming apparatus 40 in accordance with the first embodiment.

FIG. 3 is a block diagram showing a configuration of an information processing terminal 42.

FIG. 4 includes illustrations of security setting windows displayed on a display unit 62.

FIG. 5 is a flowchart representing a control structure of a program for realizing an operation when print data is received, executed by image forming apparatus 40.

FIG. 6 shows output examples of the generated banner pages.

FIG. 7 is a flowchart representing a control structure of a program for realizing an operation when print data is received, executed by an image forming apparatus in accordance with a second embodiment.

FIG. 8 is a flowchart representing a control structure of a program for realizing an operation when print data is received, executed by an image forming apparatus in accordance with a third embodiment.

FIG. 9 is a flowchart representing a control structure of a program for realizing an operation when an input operation by the user is received, executed by an information processing terminal in accordance with a fourth embodiment.

FIG. 10 is a flowchart representing a control structure of a program for realizing an operation when an input operation by the user is received, executed by an information processing terminal in accordance with a fifth embodiment.

FIG. 11 is a flowchart representing a control structure of a program for realizing an operation when an input operation by the user is received, executed by an information processing terminal in accordance with a sixth embodiment.

FIG. 12 is a schematic illustration showing the operating unit of the image forming apparatus.

FIGS. 13 and 14 show windows for setting print items of the banner page.

FIG. 15 shows an output example of the generated banner page.

### DESCRIPTION OF THE PREFERRED EMBODIMENTS

In the following, specific embodiments of the present invention will be described. In the following description and in the drawings, the same components are denoted by the same reference characters and same names. Their functions are also the same. Therefore, detailed description thereof will not be repeated.

### First Embodiment

—Configuration—

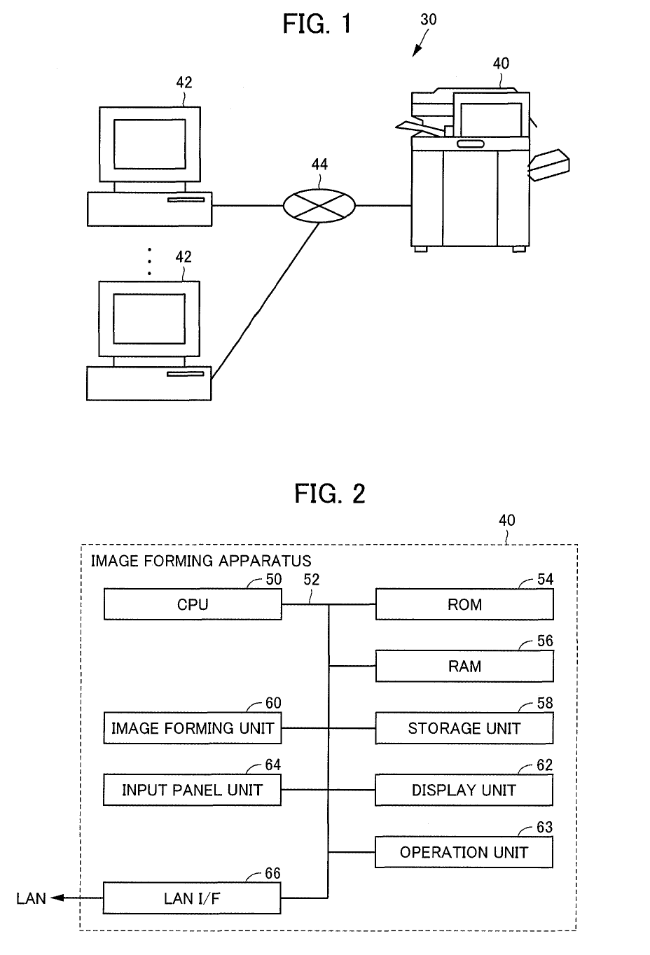

Referring to FIG. 1, a print system 30 in accordance with the first embodiment includes: an image forming apparatus 40 connected to LAN 44 for printing images; and one or a plurality of information processing terminals 42 connected to LAN 44 for transmitting print data to image forming apparatus 40. In print system 30, print data is transmitted from information processing terminal 42 to image forming apparatus 40 through LAN 44. Receiving the print data, image forming apparatus 40 analyzes the print data and forms and outputs an image on a sheet of recording paper.

Communication between information processing terminal 42 and image forming apparatus 40 is done in accordance with LPR protocol. An administrator of image forming apparatus 40 sets image forming apparatus 40 in advance such that a banner page is generated and printed if data is received in accordance with the LPR protocol.

Further, in print system 30, various pieces of information are transmitted/received between image forming apparatus 40 and information processing terminal 42 through LAN 44.

Referring to FIG. 2, image forming apparatus 40 includes: a CPU (Central Processing Unit) 50 executing a prescribed program for overall control of image forming apparatus 40; a bus 52 connected to CPU 50; an ROM (Read-Only Memory 54) for storing a program to be executed by CPU 50; an RAM (Random Access Memory) 56 operating as a temporary storage memory of CPU 50; a display unit 62 for displaying various pieces of information of image forming apparatus 40; an operation unit 63 and an input panel unit 64 for receiving an input operation from an administrator; a storage unit 58 for storing various pieces of information input through operation unit 63 and input panel unit 64; an LAN interface 66 for providing connection to the LAN; and an image forming unit 60 for printing image data and banner page data generated from the print data received through LAN interface 66 on a sheet of recording paper, all connected to bus 52.

Input panel unit 64 is a touch panel, arranged to be superposed on display unit 62.

Receiving the print data, image forming apparatus 40 stores the print data in RAM 56, analyzes the data, and converts the data to image data. By a converting process carried out by a program, bit map data as the image data are generated. Based on the data, image forming apparatus 40 causes image forming unit 60 to print on a sheet of recording paper. The sheet of recording paper after printing by image forming unit 60 is discharged to a discharge tray, not shown.

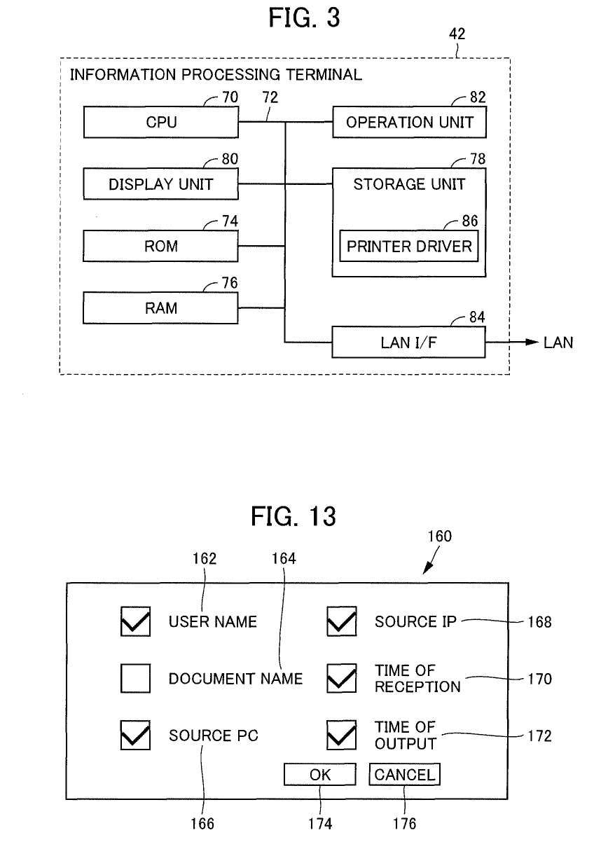

Referring to FIG. 3, information processing terminal 42 includes: a CPU 70 executing a prescribed program for overall control of information processing terminal 42; a bus 72 connected to CPU 70; an ROM 74 for storing a program to be executed by CPU 70; an RAM 76 operating as a temporary storage memory of CPU 70; a display unit 80 for displaying various pieces of information of information processing terminal 42; an operation unit 82 for receiving an input operation by a user; a storage unit 78 for storing various application programs; and an LAN interface 84 for providing connection to the LAN, all connected to bus 72.

Storage unit 78 stores a printer driver 86 for forming print data that can be processed by image forming apparatus 40. When a print instruction is received from a user on an application being executed, information processing terminal 42 calls and executes printer driver 86 to form print data, and transmits the resulting data to image forming apparatus 40.

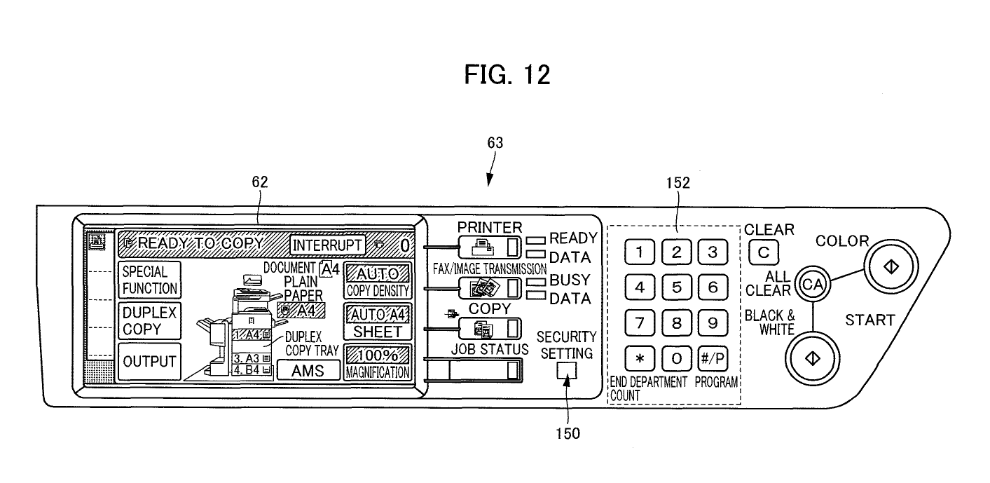

FIG. 12 is a schematic illustration of operation unit 63 of image forming apparatus 40. Referring to FIG. 12, operation unit 63 includes: ten keys 152 of hardware keys; and a security setting button 150 for making a transition to a security setting window, which will be described later. When an administrator operates security setting button 150 and inputs an identification number of the administrator using ten keys 152, image forming apparatus 40 displays the security setting window on display unit 62.

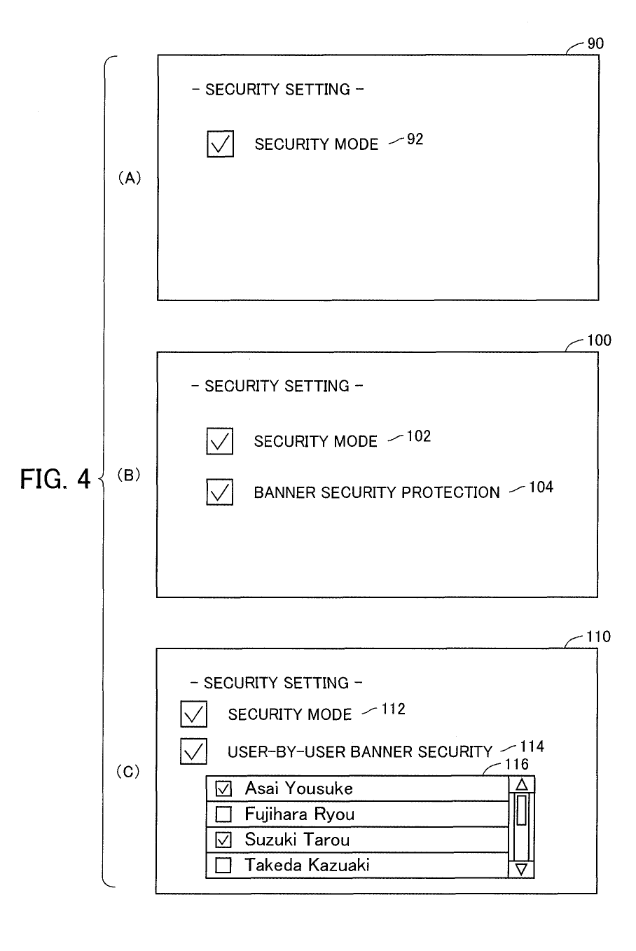

FIG. 4(A) shows a security setting window 90 used in image forming apparatus 40 in accordance with the first embodiment. Referring to FIG. 4(A), security setting window 90 includes a security mode setting button 92. On display unit 62, input panel unit 64 is superposed. When the administrator presses security mode setting button 92, the button is checked, and the image forming apparatus is set to the security mode.

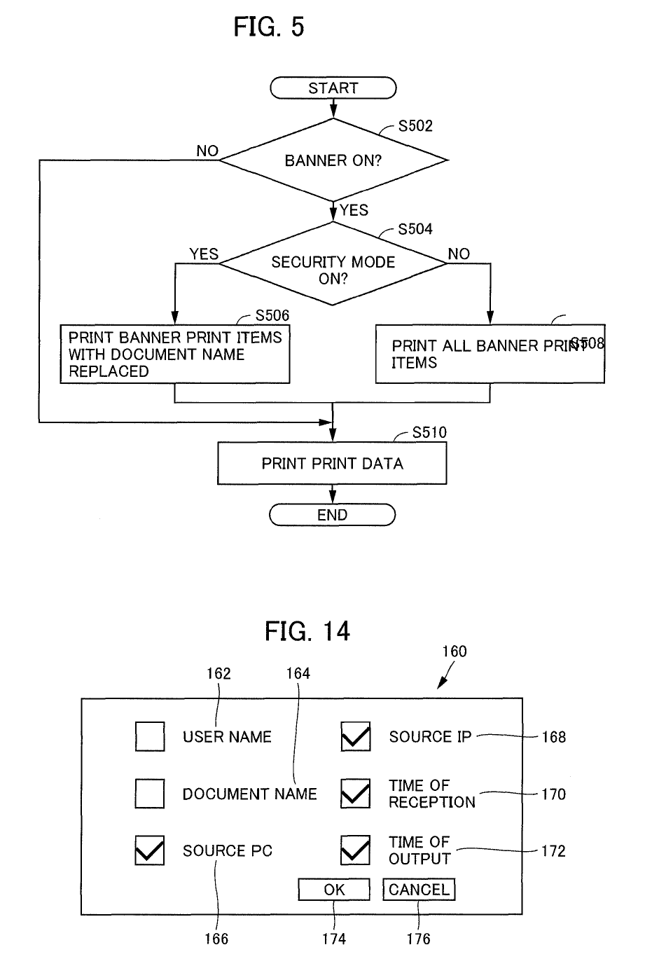

Referring to FIG. 5, the program is executed by image forming apparatus 40 when print data is received from information processing terminal 42. The program includes: a step (hereinafter simply denoted by “S”) 502 of determining whether or not image forming apparatus 40 is set to print a banner page or not, and branching the control flow depending on the result of determination; S504, executed if the determination at S502 is YES, of determining whether or not the image forming apparatus is set to the security mode, and branching the control flow depending on the result of determination; S506, executed if the determination at S504 is YES, of analyzing the received data, generating banner page data with document name of the print data replaced by asterisks “*” and printing the same; S508, executed if the determination at S504 is NO, of analyzing the received data, generating banner page data including all print items of the banner page and printing the same; and S510 executed after S506 and S508, or if the determination at S502 is NO, of analyzing the received print data and printing the same. After execution of S510, the program ends.

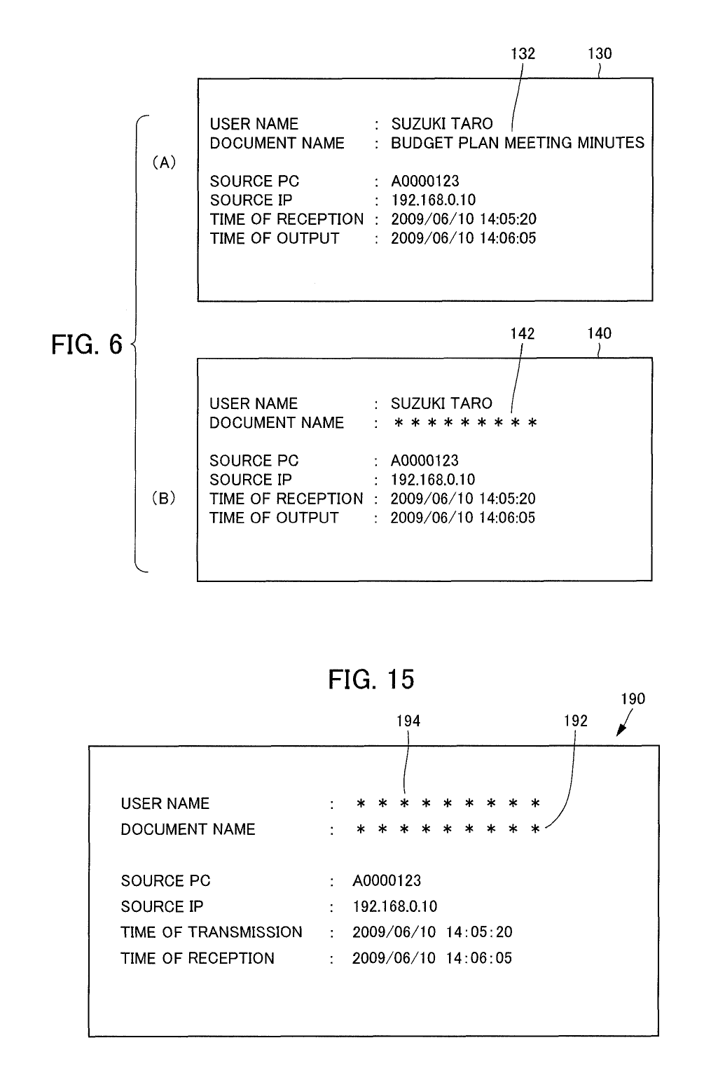

Referring to FIG. 6, FIG. 6(A) shows an output example of a common banner page 130 output when S508 of the program shown in FIG. 5 is executed. Common banner page 130 includes display items of user name, document name 132, source PC name representing the information processing terminal that transmitted the print data, source IP, time of reception of the print data and the time of output of the banner page. These display items are set in advance by an administrator, and on common banner page 130, contents of all the set display items are displayed. Further, on common banner page 130, the file name to be printed is displayed as document name 132.

FIG. 6(B) shows an output example of a security-protected banner page 140 output when S506 of the program shown in FIG. 5 is executed. Security-protected banner page 140 includes the same display items as common banner page 130, and contents of the items are displayed. It is noted, however, that in security-protected banner page 140, asterisks “*” are displayed as document name 142, so that the file name to be printed cannot be known.

—Operation—

Image forming apparatus 40 and information processing terminal 42 in accordance with the first embodiment operate in the following manner.

<Initialization of Image Forming Apparatus>

In image forming apparatus 40, whether a banner page is to be generated and printed upon reception of data in accordance with the LPR protocol is set in advance by the administrator of image forming apparatus 40. Further, whether or not image forming apparatus 40 is to be operated in the security mode at the time of generating the banner page is set in advance by the administrator, using security setting window 90 of image forming apparatus 40. Such pieces of setting information are stored in storage unit 58.

<Operation of Information Processing Terminal>

Information processing terminal 42 receives an input of user name from the user of the terminal at the time of log-in to the terminal. The input user name is transmitted as user name information to image forming apparatus 40, when the print data is transmitted. When a print instruction is received from the user, information processing terminal 42 forms print data that can be processed by image forming apparatus 40 using printer driver 68, and transmits the data to image forming apparatus 40 through LAN 44 in accordance with the LPR protocol. The print data transmitted at this time includes, as additional information, the user name, the document name to be printed (file name), name of the source PC and the IP address of the source PC, which are displayed when the banner page is formed.

<Operation of Image Forming Apparatus 40 when Print Data is Received>

When the print data is received, image forming apparatus 40 determines whether or not image forming apparatus 40 is set to print a banner page (S502). If it is not set to print the banner page, image forming apparatus 40 prints the received print data, and the operation ends. If it is set to print the banner page, image forming apparatus 40 further determines whether or not image forming apparatus 40 is set to the security mode (S504). If the image forming apparatus is not set to the security mode, it generates and prints common banner page 130 using the additional information included in the print data (S508). Thereafter, the received print data are printed, and the operation ends. If image forming apparatus 40 is set to the security mode, image forming apparatus 40 generates the banner page using the additional information included in the print data. Here, security-protected banner page 140 with the document name replaced by asterisks “*” is generated. Image forming apparatus 40 prints security-protected banner page 140 (S508), and thereafter prints the received print data, and the operation ends.

As described above, in the image forming apparatus in accordance with the first embodiment, when the banner page is formed, whether or not image forming apparatus 40 is set to the security mode is confirmed, and the contents to be displayed on the banner page can be changed depending on the mode. Therefore, even when a banner page is to be output to distinguish printouts from those output by another user, display of sensitive information (for example, printed file name) on the banner page can be controlled. As a result, an image forming apparatus having the function of forming a banner page with improved security function can be provided.

In the present embodiment, in the security mode, a page image with the document name replaced by asterisks “*” is generated for the banner page. The change of the banner page is not limited to such a manner. A banner page in which the item of document name is removed may be formed. The item to be changed is not limited to the document name, and the administrator may change the items as needed.

When forming a banner page in the security mode, information related to the conditions of print setting may be generated and applied to the image forming apparatus, so that the print setting of the image forming apparatus is changed when printing the changed banner page. The print setting to be changed may include setting of a paper tray for printing the banner page using a specific sheet of paper, and setting of print color of the banner page. Such print setting may be set in advance by the administrator using functions provided in the image forming apparatus, and stored in storage unit 58. When the banner page is printed in accordance with specific print setting, for example, when the color of banner page printing sheet and the color of printing the banner page are set to similar colors, it can be made harder to recognize the contents described on the banner page. As a result, it becomes difficult to grasp the contents on the banner page, and thus, leakage of information to a third party can be prevented.

### Second Embodiment

In the image forming apparatus in accordance with the second embodiment, it is possible to set the image forming apparatus to the security mode and to set the banner page in the security mode. The hardware configurations of the image forming apparatus and the information processing terminal in accordance with the second embodiment are the same as those of image forming apparatus 40 and information processing terminal 42 in accordance with the first embodiment. It is noted, however, that the program executed by CPU 50 of the image forming apparatus is different in the second embodiment.

—Configuration—

Referring to FIG. 4, FIG. 4(B) shows a security setting image 100 used in the image forming apparatus in accordance with the second embodiment. Security setting window 100 includes a security mode setting button 102, and a banner page security-protection setting button 104. On display unit 62, input panel unit 64 is superposed, and when each setting button is pressed by the administrator, a check mark is placed and the setting is stored.

By the setting of banner page security-protection information, it is possible to set items to be displayed on the banner page when the image forming apparatus is in the security mode. In the image forming apparatus in accordance with the second embodiment, when security-protection setting button 104 is pressed and checked on security setting window 100, a banner print item setting window 160 shown in FIG. 13 is displayed.

Referring to FIG. 13, banner print item setting window 160 includes: a setting button 162 for setting whether or not the user name is to be displayed on the banner page; a setting button 164 for setting whether or not the document name is to be displayed; a setting button 166 for setting whether or not the source PC name that transmitted the print data is to be displayed; a setting button 168 for setting whether or not the IP address of the source PC is to be displayed; a setting button 170 for setting whether or not the time of reception of the print data is to be displayed; a setting button for setting whether or not the time of output of the banner page is to be displayed; an OK button 174 for storing the pieces of information set by setting buttons 162 to 172; and a cancel button 176 for ending the banner print item setting image without storing the settings. The pieces of information set by banner print item setting image 160 are stored in storage unit 58.

When the setting button is pressed on banner print item setting window 160, a check box corresponding to each button is checked, and the display item to be displayed on the banner page is set. An item that is not checked is set as a print excluded item of the banner page. If an item is set to be the print excluded item, the contents of the corresponding item are displayed replaced by asterisks “*” on the output banner page. On banner print item setting window 160 shown in FIG. 13, the document name is the print excluded item. When the banner page is printed with this setting, a banner page such as shown in FIG. 6(B) is output.

In banner print item setting image 160 shown in FIG. 14, the document name and the user name are set as print excluded items. The output result when the banner page is printed with this setting is shown in FIG. 15. FIG. 15 shows a security-protected banner page 190 formed based on the banner print item setting image shown in FIG. 14. Referring to FIG. 15, security-protected banner page 190 includes a document name 192 and a user name 194. Based on the setting of FIG. 14, in security-protected banner page 190, contents to be displayed of document name 192 and user name 194 are replaced by asterisks “*”.

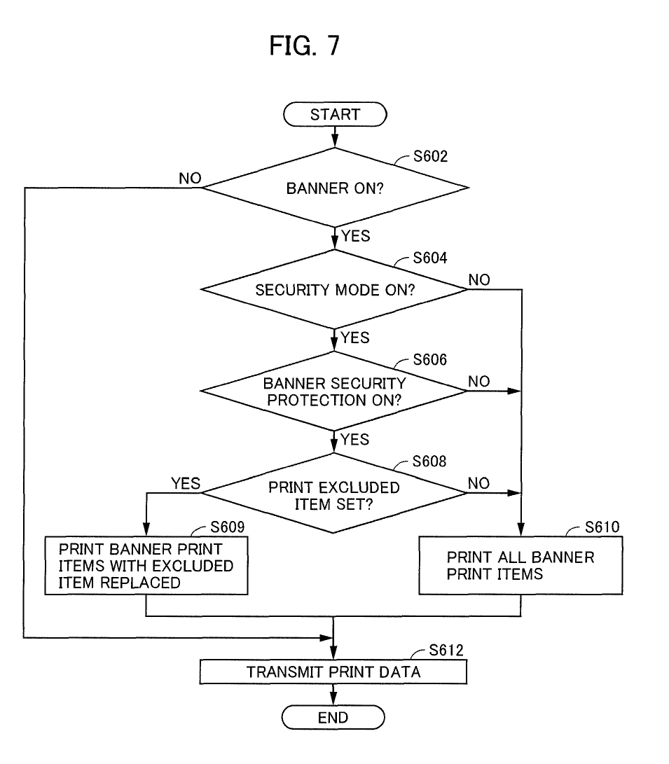

Referring to FIG. 7, the program executed by CPU 50 of the image forming apparatus when the image forming apparatus in accordance with the second embodiment received the print data includes: S602 of determining whether or not the image forming apparatus is set to print a banner page, and branching the control flow depending on the result of determination; S604, executed if the determination at S602 is YES, of determining whether or not the image forming apparatus is set to the security mode, and branching the control flow depending on the result of determination; S606, executed if the determination at S604 is YES, of determining whether security protection is set for the banner page, and branching the control flow depending on the result of determination; S608, executed if the determination at S606 is YES, of determining whether or not an item of which printing is excluded is set in the banner page print item setting, and branching the control flow depending on the result of determination; S609, executed if the determination at S608 is YES, of analyzing the received data, generating banner page data with the print excluded item replaced by asterisks “*” in accordance with the banner page print item setting, and printing; S610, executed if the determination at S604, S606 or S608 is NO, of analyzing the received data, generating banner page data displaying all print items of the banner page, and printing; and S612, executed after execution of S609 and S610, or if the determination at S602 is NO, of analyzing the received data and printing. After execution of S612, the program ends.

—Operation—

The image forming apparatus and the information processing terminal in accordance with the second embodiment operate in the following manner. It is noted that the operation of the information processing terminal is the same as that of information processing terminal 42 in accordance with the first embodiment and, therefore, description thereof will not be repeated.

<Initialization of Image Forming Apparatus>

In the image forming apparatus in accordance with the second embodiment, whether or not a banner page is to be formed and printed when data is received in accordance with the LPR protocol is set in advance by the administrator of the image forming apparatus. In the image forming apparatus, whether or not it should operate in the security mode when the banner page is generated is set using security setting window 100, and how the contents of items are to be displayed on the banner page output when the apparatus is operating in the security mode is set using banner print item setting window 160, by the administrator in advance. These pieces of setting information are stored in storage unit 58.

<Operation of Image Forming Apparatus when Print Data is Received>

When the print data is received, the image forming apparatus determines whether or not the image forming apparatus is set to print a banner page (S602). If it is not set to print the banner page, the image forming apparatus prints the received print data, and the process ends. If it is set to print the banner page, the image forming apparatus further determines whether or not it is set to operate in the security mode (S604). If it is set to operate in the security mode, whether or not the security protection is set for the banner page is determined (S606). If the determination at S606 is YES, whether or not a print excluded item of the banner page is set or not on banner print item setting window 160 is determined (S608). The image forming apparatus generates a banner page using the additional information included in the print data. If a print excluded item is set for the banner page, the image forming apparatus forms a banner page with the contents of print excluded item replaced by asterisks “*”. The image forming apparatus prints the banner page (S609), and thereafter prints the received print data, and the process for the print data ends (S612).

If the determination at S604, S606 or S608 is NO, the image forming apparatus generates and prints common banner page 130 using the additional information included in the print data (S610). Thereafter, the image forming apparatus prints the received print data, and the process ends.

As described above, in the image forming apparatus in accordance with the second embodiment, if it is set to operate in the security mode when the banner page is formed and if security protection is set for the banner page, it is possible to set an item of which printing on the banner page is to be excluded. Since the contents of display can be changed in accordance with the security protection setting, it becomes possible to prevent important information on the banner page from being read by other users. As a result, in the image forming apparatus having a function of forming a banner page, the security function can further be improved while maintaining as much as possible the functions of the banner page.

In the present embodiment, as in the first embodiment, for the banner page in the security mode, the print setting of the image forming apparatus may be changed at the time of printing the banner page with the contents to be printed changed.

### Third Embodiment

In the image forming apparatus in accordance with the third embodiment, it is possible to set whether or not a banner page is to be printed and whether or not the apparatus is to operate in the security mode. In the image forming apparatus, when it is operating in the security mode, it is possible to set the security protection setting for the banner page user by user. The hardware configurations of the image forming apparatus and the information processing terminal in accordance with the third embodiment are the same as those of image forming apparatus 40 and information processing terminal 42 in accordance with the first embodiment. It is noted, however, that the program executed by CPU 50 of the image forming apparatus is different in the third embodiment.

Referring to FIG. 4, FIG. 4(C) shows a security setting window 110 used in the image forming apparatus in accordance with the third embodiment. Security setting window 110 includes: a security mode setting button 112; a security-protection setting button 114 for setting security protection of the banner page user by user; and a user name list 116. On security setting window 110, when security-protection setting button 114 is pressed, the user name list 116 is enabled. By touching a user name in the enabled user name list 116, the administrator can select a user whose security protection is to be made effective.

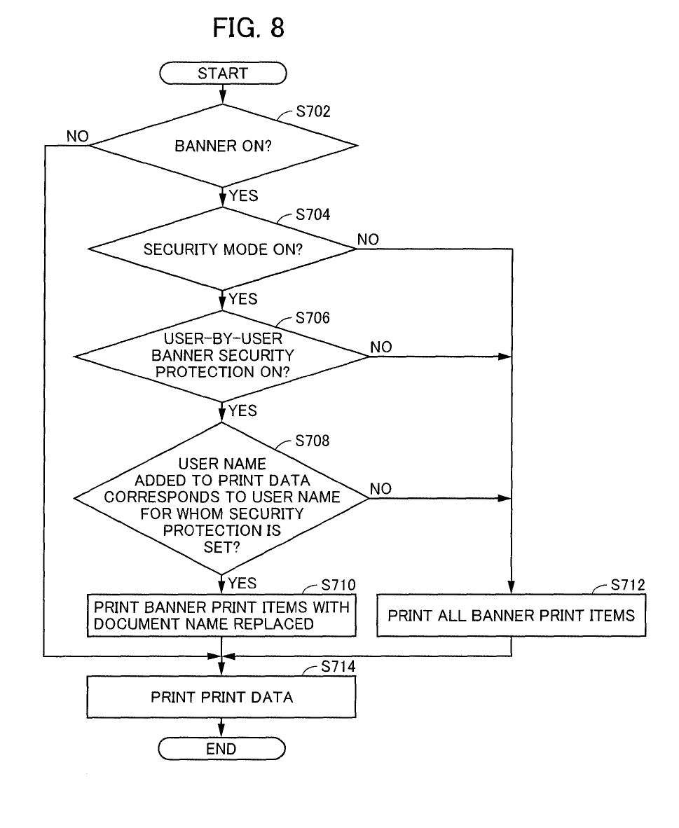

Referring to FIG. 8, the program executed by CPU 50 of the image forming apparatus when the print data is received includes: S702 of determining whether or not the image forming apparatus is set to print a banner page, and branching the control flow depending on the result of determination; S704, executed if the determination at S702 is YES, of determining whether or not the image forming apparatus is set to the security mode, and branching the control flow depending on the result of determination; and S706, executed if the determination at S704 is YES, of determining whether security protection is set for the banner page user by user, and branching the control flow depending on the result of determination. The program further includes: S708, executed if the determination at S706 is YES, of analyzing the received data, determining whether or not the user name included in the additional information of print data is selected as the user whose security protection is to be effected, and branching the control flow depending on the result of determination; S710, executed if the determination at S708 is YES, of analyzing the received data, and generating and printing banner page data with the document name of print data replaced by asterisks “*”; and S714, executed following S710, of analyzing and printing the received print data.

The program further includes: S712, executed if the determination at S704 is NO (the image forming apparatus is not set to the security mode), the determination at S706 is NO (user-by-user security protection is not set), or the determination at S708 is NO (the user is not selected as the user whose security protection is to be effected), of analyzing the received data and generating and printing banner page data including all print items of the banner page. After execution of S712, control proceeds to S714, and after execution of S714, the program ends. If the determination at S702 is NO (printing of banner page is not set), the control proceeds to S714, and after execution of S714, the program ends.

—Operation—

The image forming apparatus and the information processing terminal in accordance with the third embodiment operate in the following manner. It is noted that the operation of the information processing terminal is the same as that of information processing terminal 42 in accordance with the first embodiment and, therefore, description thereof will not be repeated.

<Initialization of Image Forming Apparatus>

In the image forming apparatus in accordance with the third embodiment, whether or not the banner page is to be generated and printed when the print data is received in accordance with the LPR protocol is set in advance by the administrator of the image forming apparatus. In the image forming apparatus, whether or not it is to operate in the security mode at the time of forming the banner page, whether or not the user-by-user security protection is to be effected when the banner page is formed, and if the user-by-user security protection is to be effected, security protection of which user is to be effected are set in advance by the administrator, using security setting window 110. The pieces of setting information are stored in storage unit 58.

<Operation of Image Forming Apparatus when Print Data is Received>

When the print data is received, the image forming apparatus determines whether or not image forming apparatus is set to print a banner page (S702). If it is not set to print the banner page, the image forming apparatus prints the received print data, and the process ends. If it is set to print the banner page, the image forming apparatus further determines whether or not it is set to the security mode (S704). If it is set to the security mode, the image forming apparatus determines whether or not user-by-user security protection is set at the time of forming the banner page (S706). If the determination at S706 is YES (user-by-user security protection is set), the image forming apparatus analyzes the received print data, and determines whether or not the user name included in the additional information of print data is selected as the user whose security protection is to be effected (S708). If the determination at S708 is YES, the image forming apparatus analyzes the received print data, generates and prints banner page 140 with the document name of the print data replaced by asterisks “*” using the additional information (S710), and thereafter prints the received print data, and thus the process ends (S714).

If the determination at S704 is NO (the image forming apparatus is not set to the security mode), the determination at S706 is NO (user-by-user security protection is not set), or the determination at S708 is NO (the user is not selected as the user whose security protection is to be effected), banner page 130 including all print items of the banner page is generated and printed using additional information included in the print data (S712). Thereafter, the received print data is printed and the process ends.

As described above, in the image forming apparatus in accordance with the third embodiment, it is possible to set user by user whether the banner page security protection is to be effected or not. For a specific user, the contents to be displayed on the banner page can be changed and output. Therefore, it becomes possible to prevent important information on the banner page from being read by other users. As a result, in the image forming apparatus capable of setting security function user by user and having a function of forming a banner page, display can be controlled finely in accordance with the intention of management by the administrator.

In the present embodiment, in the banner page of the user set as the object of security protection, the document name is replaced by asterisks “*”. The change of the banner page is not limited to the above. A banner page in which the item of document name is removed may be formed. The item of which output contents can be changed is not limited to the document name, and the administrator may change the output contents of any item as needed.

In the present embodiment, as in the first and second embodiments, for the banner page in the security mode, the print setting of the image forming apparatus may be changed at the time of printing the banner page with the contents changed in accordance with the user-by-user setting.

### Fourth Embodiment

In the first to third embodiments, the banner page is formed in the image forming apparatus that received the print data. In the embodiments that follow, the banner page is generated not by the image forming apparatus. In the fourth embodiment, banner page data is generated by an information processing terminal based on various pieces of information set in the image forming apparatus and transmitted to the image forming apparatus.

The hardware configurations of the image forming apparatus and the information processing terminal of the print system in accordance with the fourth embodiment are the same as those of image forming apparatus 40 and information processing terminal 42 in accordance with the first embodiment. It is noted, however, that the program executed by the image forming apparatus and the program executed by the information processing terminal are different.

—Configuration—

As in the first embodiment, in the image forming apparatus in accordance with the fourth embodiment, the security setting window 90 such as shown in FIG. 4(A) is used. In the image forming apparatus, whether the security mode is applied or not is determined in advance by the administrator of the image forming apparatus, using this window.

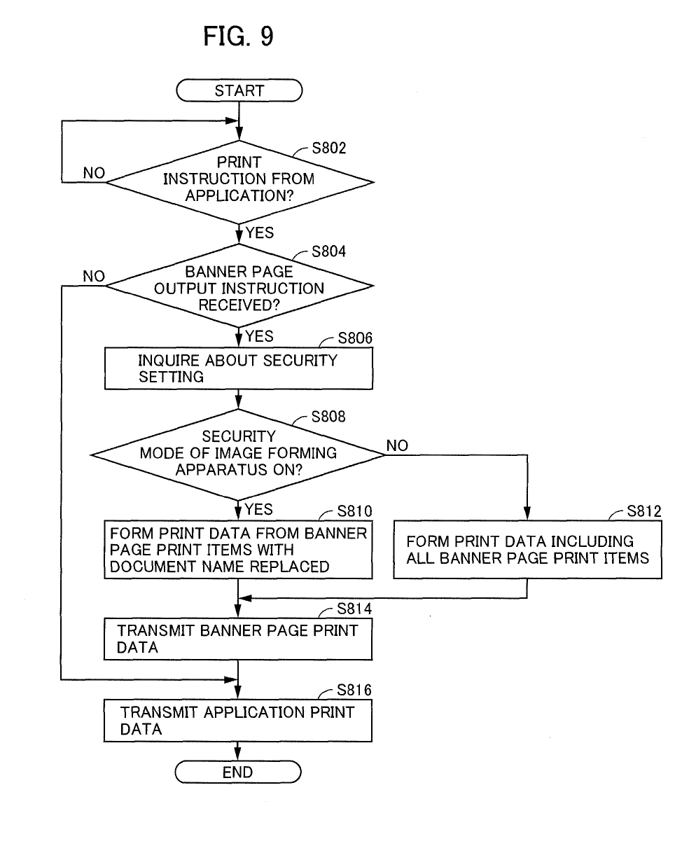

Referring to FIG. 9, the program executed by CPU 70 of the information processing terminal in accordance with the present embodiment includes: S802 of waiting for a print instruction from a user on an application that is being executed; S804, executed if it is determined at S802 that a print instruction is received, of determining whether or not an instruction to output a banner page is received on a dialog box (not shown) receiving detailed instructions related to printing, and branching the control flow depending on the result of determination; and S806, executed if the determination at S804 is YES, of sending out an inquiry to the image forming apparatus about the security setting information set in advance, through a communication line (for example, LAN). The program further includes: S808, executed following S806, of determining whether or not the image forming apparatus is set to the security mode based on the security setting information received from the image forming apparatus, and branching the control flow depending on the result of determination; S812, executed if the determination at S808 is NO (the image forming apparatus is not set to the security mode), of obtaining pieces of information related to all items to be displayed on the banner page from the inside of information processing terminal and forming print data of the banner page; S810, executed if the determination at S808 is YES (the image forming apparatus is set to the security mode), of obtaining pieces of information related to all items to be displayed on the banner page from the inside of information processing terminal and forming print data of the banner page with the information related to the document name replaced by asterisks “*”; S814, executed following S810 or S812, of transmitting the print data of banner page formed at S810 or S812 to the image forming apparatus; and S816, executed following S814, of transmitting the print data generated by printer driver 86 as application print data to the image forming apparatus. If the determination at S804 is NO (banner page output setting is not received), the control proceeds to S816. After the process of transmitting only the print data to the image forming apparatus is executed at S816, the program ends.

When the banner page is to be printed, a print job for the banner page and a print job for the print data are transmitted in this order from the information processing terminal to the image forming apparatus. Therefore, when the image forming apparatus receives the print data, what is required of the image forming apparatus is simply to print it, no matter whether it is the data of banner page or ordinary print data. When printing of a banner page is not designated, only the print job of print data is transmitted from the information processing terminal to the image forming apparatus. Therefore, in this case also, what the image forming apparatus should do is simply to print the received print job or jobs in order.

—Operation—

The image forming apparatus and the information processing terminal in accordance with the fourth embodiment operate in the following manner.

<Initialization of Image Forming Apparatus>

In the image forming apparatus in accordance with the fourth embodiment, using the window shown in FIG. 4(A), whether or not it is to operate in the security mode is set in advance by the administrator. The security setting information is stored in storage unit 58.

<Operation of Information Processing Terminal>

In the fourth embodiment, the user of the information processing terminal inputs the user name at the time of log-in to the terminal. The input user name is stored as the user name information, in the information processing terminal. When the information processing terminal receives a print instruction from the user on the application that is active (S802), it displays a dialog box for receiving detailed instructions related to printing. On the dialog box, there is an item for designating whether or not a banner page is to be output. Receiving a print instruction through the dialog, the information processing terminal determines whether or not an instruction to output the banner page is received (S804). If the instruction to output the banner page is received (YES at S804), security setting information of the image forming apparatus is obtained through LAN (S806). If the image forming apparatus is not set to operate in the security mode (NO at S808), the information processing terminal obtains pieces of information related to all the items to be displayed on the banner page from the inside of the terminal, and forms print data for the banner page (S812). If the image forming apparatus is set to operate in the security mode (YES at S808), the information processing terminal obtains pieces of information related to all the items to be displayed on the banner page from the inside of the terminal, and forms print data for the banner page with the information related to the document name replaced by asterisks “*” (S810). The formed print data of the banner page is transmitted to the image forming apparatus. Thereafter, based on the data of which print instruction is received on the application, the printer driver generates print data that can be processed by the image forming apparatus, and transmits the data as application print data to the image forming apparatus (S816).

If a print instruction of banner page is not given through the dialog (NO at S804), the banner page print job is not transmitted, and only the print job of print data is transmitted to the image forming apparatus.

<Operation of Image Forming Apparatus when Print Data is Received>

When the image forming apparatus receives the print data from the information processing terminal, it prints the data in the order of reception. Therefore, when a print job of banner page and a print job of print data are transmitted in this order from the information processing terminal, the apparatus prints these in the order of reception. When only the print job of print data is received, it prints the print job, without printing the banner page.

As described above, in the print system in accordance with the fourth embodiment, in response to reception of a print instruction and a banner page output instruction, the information processing terminal reads setting information related to the security of the image forming apparatus. Then, the information processing terminal forms banner page data in accordance with the security setting information of the image forming apparatus, and transmits it to the image forming apparatus. Since the banner page data is formed based on the security setting information set in the image forming apparatus, the banner page can be formed applying the same security setting conditions, no matter which information processing terminal is used to issue a print instruction. As a result, a print system in which security setting can be done uniformly in forming the banner page information can be provided.

When a CPU in an image forming apparatus is compared with a CPU in an information processing terminal, the CPU in the information processing terminal generally has higher performance. In the fourth embodiment, the information processing terminal forms and transmits the banner page data and, therefore, the load at the time of forming the banner page data on the image forming apparatus can be alleviated, and image forming process can be done with higher efficiency. As a result, improved security at the time of outputting banner page can be attained while the image forming apparatus can be operated with higher efficiency.

In the present embodiment, an information processing terminal has been described as an example of the apparatus that generates banner page data other than the image forming apparatus. Available apparatus, however, is not limited to the information processing terminal. For example, the process of forming the banner page such as described above may be done by an apparatus relaying transmission of print data to the image forming apparatus, such as a printer server provided on the same LAN as the image forming apparatus.

### Fifth Embodiment

In the fifth embodiment, setting of security mode and setting of security protection for the banner page are executed by the image forming apparatus, and based on these pieces of information, the information processing terminal forms banner page data.

The hardware configurations of the image forming apparatus and the information processing terminal of the print system in accordance with the fifth embodiment are the same as those of image forming apparatus 40 and information processing terminal 42 in accordance with the first embodiment. It is noted, however, that the program executed by the image forming apparatus and the program executed by the information processing terminal are different from those of the first embodiment.

—Configuration—

In the image forming apparatus in accordance with the fifth embodiment, as in the second embodiment, a security setting window similar to security setting window 100 shown in FIG. 4(B) is used. In the image forming apparatus, by the administrator of the image forming apparatus, whether or not the security mode is to be applied, and information of banner page security setting are set in advance.

In the present embodiment, as in the first to third embodiments, by the setting of banner page security protection information, the manner of displaying contents of items to be displayed on the banner page can be changed. In the image forming apparatus, when security-protection setting button 104 is pressed and checking is done on the security setting window, a banner print item setting window similar to banner print item setting window 160 shown in FIG. 13 is displayed.

When the setting button is pressed on the banner print item setting window, a check box corresponding to each button is checked, and the display item to be displayed on the banner page is set. An item that is not checked is set as a print excluded item of the banner page. If an item is set to be the print excluded item, the contents of the corresponding item are displayed replaced by asterisks “*” on the output banner page.

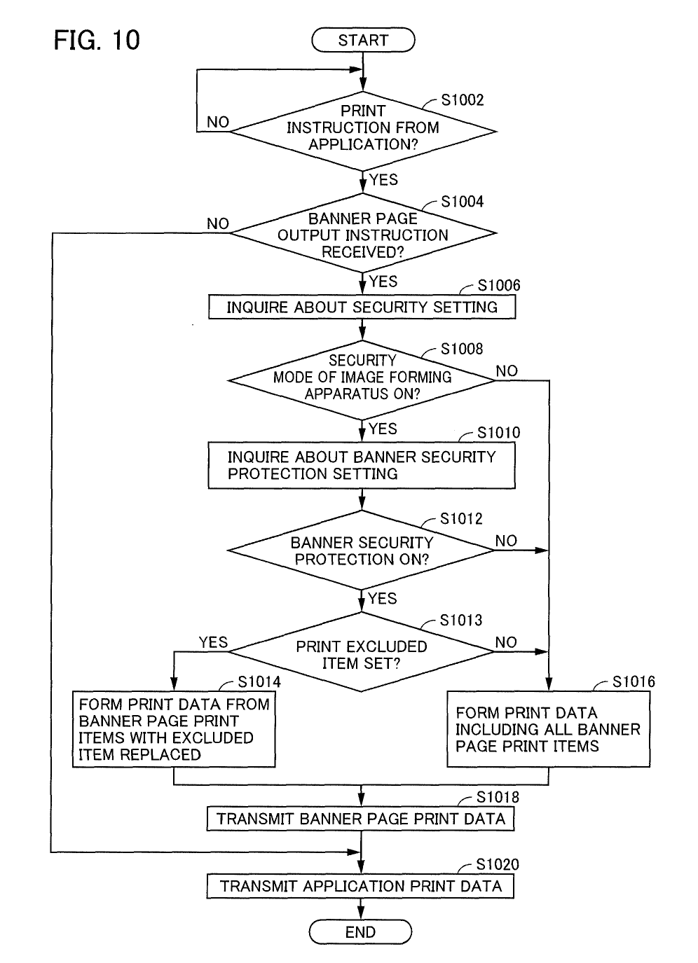

Referring to FIG. 10, in the information processing terminal in accordance with the present embodiment, the program executed by CPU 70 when an input operation is done by the user includes S1002 of waiting until a print instruction is received on the application from the user. The print instruction is passed to the program when a print dialog, not shown, is displayed by the application and the user designates necessary information thereon. The dialog includes a portion allowing input of instruction as to whether the banner page is to be output or not.

The program further includes: S1004, executed in response to determination at S1002 that a print instruction is received, of determining whether or not output of a banner page is instructed on the print dialog, and branching the control flow depending on the result of determination; and S1006, executed if it is determined at S1004 that output of banner page is instructed (YES), of sending out an inquiry to the image forming apparatus about the information related to security mode setting through a communication line.

The program further includes: S1008, executed following S1006, of determining whether or not the image forming apparatus is set to the security mode, based on the information related to security mode setting received from the image forming apparatus, and branching the control flow depending on the result of determination; S1016, executed if the determination at S1008 is NO, of obtaining pieces of information related to all the items to be displayed on the banner page from the inside of information processing terminal and forming print data of the banner page; S1010, executed if the determination at S1008 is YES, of sending out an inquiry to the image forming apparatus about whether or not the banner page security protection is set and about the contents of setting; S1012, executed following S1010, of determining whether or not the banner page security protection is set, and branching the control flow depending on the result of determination; S1013, executed if the determination at S1012 is YES, of referring to the contents of security protection setting obtained at S1010, determining whether or not a print excluded item is set on the banner page, and branching the control flow depending on the result of determination; S1014, executed if the determination at S1013 is YES, of obtaining pieces of information related to all the items to be displayed on the banner page from the inside of information processing terminal and forming print data of banner page with the information set as the print excluded item replaced with asterisks “*”; S1018, executed following S1014 or S1016, of transmitting the print data of banner page formed at S1014 or S1016 to the image forming apparatus; and S1020, executed following S1018, of printer driver 86 generating print data that can be processed by the image forming apparatus based on the print instruction received from the application, and transmitting the print data to the image forming apparatus. If the determination at S1012 is NO, or if the determination at S1013 is NO, the control proceeds to S1016. If it is determined at S1004 that the instruction to output the banner page is not received (NO), the control proceeds to S1020, at which the print data is immediately generated and transmitted without transmitting the banner page. After S1020, the program ends.

When the image forming apparatus in accordance with the fifth embodiment receives print data from the information processing terminal, it prints the data in the order of reception, no matter whether the received print data is the print data of banner page or not. Specifically, what is required of the image forming apparatus is simply the function of setting information related to security, the function of storing the information, and the function, if an inquiry is made from the outside about the information related to the security, of returning the information, and it may not have any special function related to printing.

—Operation—

The image forming apparatus and the information processing terminal in accordance with the fifth embodiment operate in the following manner.

<Initialization of Image Forming Apparatus>

In the image forming apparatus in accordance with the fifth embodiment, whether or not it is to operate in the security mode, items to be displayed on banner page 130, and items to be displayed on protected banner page 140 when the apparatus is operating in the security mode are set in advance by the administrator. These pieces of security setting information are stored in storage unit 58.

<Operation of Information Processing Terminal>

The user of the information processing terminal inputs the user name at the time of log-in to the terminal. The input user name is stored as the user name information, in the information processing terminal. When an application running on the information processing terminal receives a print instruction from the user, it displays a print dialog. The print dialog allows setting as to whether a banner page is to be printed or not. When necessary information is set and the user instructs start of printing (YES at S1002), the information processing terminal determines whether or not a banner page output instruction is received (S1004). If the banner page output instruction is received (YES at S1004), the information processing terminal obtains the security setting information from the image forming apparatus though the LAN (S1006). If the image forming apparatus is not set to the security mode (NO at S1008), the information processing terminal obtains pieces of information related to all the items to be displayed on the banner page from the inside of the terminal, forms print data for the banner page (S1016), and transmits it to the image forming apparatus (S1018). If the image forming apparatus is set to the security mode (YES at S1018), the information processing terminal obtains the setting information related to banner page security protection from the image forming apparatus (S1010). If the banner page security protection is set in the image forming apparatus (YES at S1012) and a print excluded item is set on the banner page (YES at S1013), the information processing terminal obtains pieces of information related to all the items to be displayed on the banner page from the inside of the terminal, forms print data for the banner page with the information set as the print excluded item replaced by asterisks “*” (S1014), and transmits the same to the image forming apparatus (S1018). If the banner page security protection is not set (NO at S1012), the information processing terminal obtains pieces of information related to all the items to be displayed on the banner page from the inside of the terminal, forms print data for the banner page (S1016) and transmits the same to the image forming apparatus (S1018). Following the print data for the banner page, based on the data of which print instruction is received from the application, the printer driver forms print data that can be processed by the image forming apparatus, and transmits the data as application print data, to the image forming apparatus (S1020).

If a banner page output instruction is not received on the print dialog image (NO at S1004), the information processing terminal generates only the application print data and transmits it to the image forming apparatus (S1020).

<Operation of Image Forming Apparatus when Print Data is Received>

When the image forming apparatus receives banner page print data transmitted from the information processing terminal, it prints the print data in the order of reception. As already described, the image forming apparatus need not have any special function related to printing.

As described above, in the print system in accordance with the fifth embodiment, in response to reception of a print instruction and a banner page output instruction from the user, the information processing terminal reads information related to security of the image forming apparatus as the output destination. Further, the information processing terminal forms banner page data conforming to the security setting information and transmits the data to the image forming apparatus. Here, if the image forming apparatus is set to the security mode and the banner page security protection is set, the information processing terminal forms banner page data with the contents to be displayed on the banner page changed in accordance with the contents of setting, and transmits the formed data to the image forming apparatus. Since the banner page data is formed based on the security setting information set in the image forming apparatus, the same security setting conditions are applied no matter which information processing terminal is used for issuing the print instruction. As a result, as regards the formation of banner page information, an information processing terminal that realizes security management in a consistent manner can be provided.

In the present embodiment also, the banner page data is formed and transmitted using the information processing terminal. Therefore, the load on the image forming apparatus can be alleviated. The information processing terminal generates the banner page data reflecting detailed setting contents related to security in the image forming apparatus. As a result, the security function at the time of outputting the banner page can be improved, the load on the image forming apparatus can be alleviated, and more efficient operation can be realized.

In the present embodiment, an information processing terminal has been described as the apparatus for generating the banner page data, rather than the image forming apparatus. It is also possible to use an apparatus other than the information processing terminal. For example, an apparatus relaying transmission of print data between the information processing terminal and the image forming apparatus, such as a printer server communicable with both the image forming apparatus and the information processing terminal, may be used.

### Sixth Embodiment

In the sixth embodiment, the information processing terminal formed banner page data based on the security related information as to whether the image forming apparatus is set to the security mode or not and as to the user-by-user security protection setting of the banner page, stored in the image forming apparatus.

The hardware configurations of the image forming apparatus and the information processing terminal of the print system in accordance with the sixth embodiment are the same as those of image forming apparatus 40 and information processing terminal 42 in accordance with the first embodiment. It is noted, however, that the program executed by the image forming apparatus and the program executed by the information processing terminal are different from those of the first embodiment.

—Configuration—

In the image forming apparatus in accordance with the sixth embodiment, as in the third embodiment, a security setting window similar to security setting window 110 shown in FIG. 4(C) is used. In the image forming apparatus, whether or not the image forming apparatus is to be set to the security mode, whether or not banner page security protection is to be executed user by user, and the user name for effecting security protection when the user-by-user security protection is to be executed, are set in advance by the administrator of the image forming apparatus, and the setting is stored.

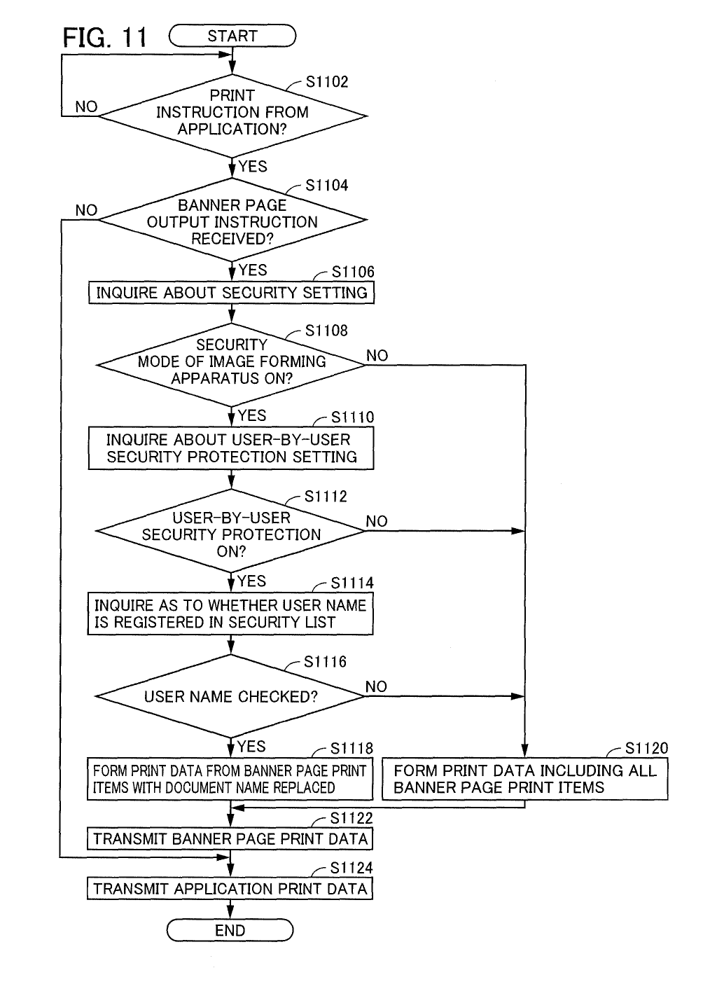

Referring to FIG. 11, the program executed by the information processing terminal in accordance with the present embodiment includes S1102 of waiting for a print instruction on an application from the user. When the user selects printing on the application, a print dialog, not shown, is displayed, allowing various settings. On the dialog, there is an item for designating whether or not a banner page is to be printed. When the user sets various pieces of information using the print dialog and instructs execution of printing, the result of determination at S1102 becomes YES.

The program further includes: S1104, executed when a print execution instruction is received from the user, of determining whether or not a banner page output instruction is received on the print dialog display, and branching the control flow depending on the result of determination; and S1106, executed if it is determined at S1104 that a banner page output instruction is received (YES), of sending out an inquiry to the image forming apparatus about the security setting information. The program further includes: S1108, executed following S1106, of determining whether or not the image forming apparatus is set in the security mode based on the security setting information received from the image forming apparatus, and branching the control flow depending on the result of determination; S1120, executed if the determination at S1108 is NO, of obtaining pieces of information related to all the items to be displayed on the banner page from the inside of the information processing terminal, and forming the print data for the banner page; S1110, executed if the determination at S1108 is YES, of inquiring whether or not the image forming apparatus is set to realize user-by-user security protection setting; S1112, executed following S1110, of determining whether or not the user-by-user security protection mode is set, from the user-by-user security protection setting information received from the image forming apparatus, and branching the control flow depending on the result of determination; S1114, executed if the determination at S1112 is YES, of inquiring whether the user name of the user using the information terminal is registered in a security list in the image forming apparatus; S1116, executed following S1114, of determining whether or not the user name of the user is registered based on the result of inquiry at S1114, and branching the control flow depending on the result of determination; S1118, executed if the determination at S1116 is YES, of obtaining information related to the items to be displayed on the banner page from the inside of the information processing terminal, and forming print data for the banner page with the information related to the document name replaced by asterisks “*”; and S1122, executed following S1118 or S1120, of transmitting the print data of the banner page formed at S1118 or S1120 to the image forming apparatus.

The program further includes S1124, executed following S1122, of printer driver 86 forming print data that can be processed by the image forming apparatus, from the data of which print instruction is received from the application, and transmitting the data as the application print data to the image forming apparatus. If the determination at S1104 is NO, the control proceeds to S1124. If the determination at S1112 or S1116 is NO, the control proceeds to S1120. After S1124, the program ends.

The image forming apparatus has a function of printing the print data in the order of reception, when print data is received from the information processing terminal. The image forming apparatus further has a function, when an inquiry is made by the information processing terminal about the information related to security, of returning the information.

—Operation—

The image forming apparatus and the information processing terminal in accordance with the sixth embodiment operate in the following manner.

<Initialization of Image Forming Apparatus>

In the image forming apparatus in accordance with the sixth embodiment, items related to common banner page 130 and security-protected banner page 140 are set in advance by the administrator. Further, from the security setting window 110 of the image forming apparatus, whether or not the image forming apparatus is set to the security mode, whether or not the user-by-user security protection is effected at the time of generating the banner page, and if the user-by-user security protection is effected, for which user the security protection is to be effected, are set. These pieces of security setting information are stored in storage unit 58.

<Operation of Information Processing Terminal>

The user of the information processing terminal inputs the user name at the time of log-in to the terminal. The input user name is stored as the user name information, in the information processing terminal. When the information processing terminal receives a print instruction on the application, it displays a dialog box for receiving detailed instructions related to printing. Among the conditions to be set, setting as to whether the banner page is to be printed or not is included. When the user sets necessary information on the print dialog box and instructs execution of printing (YES at S1102), the information processing terminal determines whether or not a banner page output instruction is received from the user (S1104). If the banner page output instruction is received (YES at S1104), the information processing terminal obtains the security setting information from the image forming apparatus (S1106). If the image forming apparatus is not set to the security mode (NO at S1108), the information processing terminal obtains pieces of information related to all the items to be displayed on the banner page from the inside of the terminal, forms print data for the banner page (S1120), and transmits the data to the image forming apparatus (S1122). If the image forming apparatus is set to the security mode (YES at S1108), the information processing terminal obtains user-by-user security protection setting information from the image forming apparatus (S1110). If it is determined that the user-by-user security protection is set in the image forming apparatus (YES at S1112), the information processing terminal sends out an inquiry to the image forming apparatus whether or not the user name of the user using the terminal is registered as the user for whom the security protection is to be effected (S1114). If the user is set as the user for whom security protection is to be effected in the image forming apparatus (YES at S1116), the information processing terminal obtains pieces of information related to items to be displayed on the banner page from the inside of information processing terminal, and forms print data of banner page with the information related to the document name replaced by asterisks “*” (S1118). After forming the print data for the banner page, the information processing terminal transmits the print data to the image forming apparatus (S1122). Following the transmission of banner page print data, the printer driver generates print data that can be processed by the image forming apparatus based on the data of which printing is instructed by the application, and transmits the data as the application print data to the image forming apparatus (S1124).

If the banner page output instruction is not received on the dialog image (NO at S1104), the information processing terminal generates only the application print data and transmits the data to the image forming apparatus.

<Operation of Image Forming Apparatus when Print Data is Received>

When the image forming apparatus receives an inquiry about security-related information from the information processing terminal, it returns appropriate information set in advance. When the image forming apparatus receives the print data from the information processing terminal, it prints the print data in the order of reception, regardless of whether the print data is for a banner page or from an application. Specifically, as regards the reception of print data, the image forming apparatus operates in exactly the same manner as the conventional apparatus.

As described above, in the print system in accordance with the sixth embodiment, the information processing terminal generates the banner page data in response to reception of a print instruction and a banner page output instruction from the user. At this time, the information processing terminal reads the security setting information of the image forming apparatus as the output destination, and if the security mode is set in the image forming apparatus and the user of the information processing terminal is set in advance as the user for whom the security protection is to be effected, the banner page data based on the security setting is formed. Since the banner page print data reflecting the security setting is formed only for the user set in advance, leakage of information from the banner page output at the time of the user printing confidential document can be prevented. Further, since the banner page data is formed on the information processing terminal based on the security setting information set on the image forming apparatus, the same security setting conditions can be applied no matter which information processing terminal is used for issuing the print instruction. As a result, an information processing terminal that can realize improved security in accordance with uniform standard in forming the banner page information can be provided.

In this embodiment also, the banner page data is generated by the information processing terminal and, therefore, load on the image forming apparatus can be alleviated, and image formation with high efficiency becomes possible. As a result, improved security function can be realized at the time of outputting the banner page, the load on the image forming apparatus can be alleviated and highly efficient operation becomes possible.

In the fourth to sixth embodiments above, an information processing terminal has been described as the apparatus for generating the banner page data, rather than the image forming apparatus. It is also possible to use an apparatus other than the information processing terminal. For example, an apparatus relaying transmission of print data between the information processing terminal and the image forming apparatus, such as a printer server communicable with both the image forming apparatus and the information processing terminal, may be used.

In the fourth to sixth embodiments above, the security setting related to the image forming apparatus is done using the operation unit of the image forming apparatus. It is also possible to have the information processing terminal set the security setting of image forming apparatus. By way of example, the image forming apparatus may be adapted to have a WEB server function. The information processing terminal may be configured to operate the WEB page of the image forming apparatus through a network, and thereby to set the security setting of the image forming apparatus. Alternatively, the information processing terminal may transmit to an image forming apparatus as the data transmission destination, security setting data of the apparatus. The image forming apparatus may be configured such that the security setting thereof is changed in accordance with the received security setting data.

According to the first to sixth embodiments above, in connection with the function of generating print data of a banner page inside or outside of an image forming apparatus, if an administrator turns on or off the security function of the image forming apparatus, the information to be displayed on the banner page can be changed in accordance with the state. As a result, an image forming apparatus realizing improved security function, preventing leakage of information from the contents described in the banner page, can be provided.

Further, by adding the function of setting whether or not the banner page itself is to be printed or not as in the first to sixth embodiments, adding the function of selecting an item of which printing is avoided on the banner page as in the second and fifth embodiments, and adding the function of turning on or off the security setting related to the banner page user by user as in the third and sixth embodiments, security of the image forming apparatus can be enhanced. Therefore, it is possible to appropriately set security in various manners as considered necessary by the administrator, and the security function can further be enhanced.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An image forming apparatus, comprising:
a communication device connected to receive print data;
a banner page generating device, responsive to said communication device receiving the print data, for generating a banner page displaying information related to the received print data and conditions at the time of forming an image of the page;
an image forming unit, responsive to said communication device receiving the print data, for forming the banner page generated by said banner page generating device and an image generated based on said print data on a prescribed medium; and
a security setting storage device storing security setting related to the banner page; wherein
said banner page generating device changes, in accordance with said setting stored in said security setting storage device, the information related to said banner page or the conditions at the time of forming the image of said banner page by said image forming unit.

2. The image forming apparatus according to claim 1, wherein
said security setting storage device includes a first setting storage device storing on/off setting of the security function of said image forming apparatus; and
said banner page generating device changes, in accordance with said on/off setting of the security function stored in said first setting storage device, the information to be displayed on said banner page or the conditions at the time of forming the image of said banner page by said image forming unit.

3. The image forming apparatus according to claim 2, wherein
said security setting storage device further includes a second setting storage device storing item information related to an item to be displayed on said banner page; and
said banner page generating device changes, in accordance with said on/off setting of the security function stored in said first setting storage device and said item information stored in said second setting storage device, the information to be displayed on said banner page or the conditions at the time of forming the image of said banner page by said image forming unit.

4. The image forming apparatus according to claim 3, further comprising a setting input device receiving a setting related to security of said image forming apparatus from a user and storing the setting in said security setting storage device.

5. The image forming apparatus according to claim 1, wherein
the print data additionally has user information identifying a user who instructed printing of the print data;
said security setting storage device includes a first setting storage device storing information for setting user by user on/off of the security function of said image forming apparatus;
said banner page generating device changes, in accordance with the user-by-user on/off setting of said security function stored in said first setting storage device and the user information added to the print data received by said communication device, the information to be displayed on said banner page or the conditions at the time of forming the image of said banner page by said image forming unit.

6. The image forming apparatus according to claim 1, wherein
said security setting storage device further includes a first setting storage device storing item information related to an item to be displayed on said banner page; and
said banner page generating device changes, in accordance with said item information stored in said first setting storage device, the information to be displayed on said banner page or the conditions at the time of forming the image of said banner page by said image forming unit.

7. The image forming apparatus according to claim 1, further comprising a setting input device receiving a setting related to security of said image forming apparatus from a user and storing the setting in said security setting storage device.

8. A print instructing apparatus, comprising:
an image forming unit, responsive to an instruction from a user, for generating print data to be transmitted to and printed by an image forming apparatus;
an inquiry device, responsive to said instruction, for sending out an inquiry to said image forming apparatus about security-related setting of the image forming apparatus;
a banner page generating device for generating, based on the security-related setting of said image forming apparatus obtained by said inquiry device, a print job of a banner page having contents made different depending on whether security function is on or off in said image forming apparatus; and
a transmission device for transmitting the print job of a banner page generated by said banner page generating device and the print data generated by said image forming unit, to said image forming apparatus.

9. The print instructing apparatus according to claim 8, wherein said banner page generating device further changes, if the security function is on in said image forming apparatus, contents of the banner page based on the security-related setting of said image forming apparatus.

10. The print instructing apparatus according to claim 8, wherein said banner page generating device sets, if the security function is on in said image forming apparatus, contents of the banner page based on the security-related setting of said image forming apparatus and user information of a user operating the print instructing apparatus.

11. A print instructing method, comprising the steps of:
in response to an instruction from a user, generating print data to be transmitted to and printed by an image forming apparatus;
in response to said instruction, sending out an inquiry to said image forming apparatus about security-related setting of the image forming apparatus;
based on the security-related setting of said image forming apparatus obtained at said inquiry step, generating a print job of a banner page having contents made different depending on whether security function is on or off in said image forming apparatus; and
transmitting the print job of a banner page generated at said print job generating step and the print data generated at said print data generating step, to said image forming apparatus.
